(19) United States
(12) Patent Application Publication
(10) Pub. No.: US 2019/0168132 A1
(43) Pub. Date: Jun. 6, 2019

(54) Modular Extraction Column

(71) Applicants: Youngmoon Bae, Daejeon (KR); Seungchul Yang, Daejeon (KR); Byungkuk Lee, Sejong (KR); Dongyong Kwak, Daejeon (KR); Junsang Min, Seoul (KR)

(72) Inventors: Youngmoon Bae, Daejeon (KR); Seungchul Yang, Daejeon (KR); Byungkuk Lee, Sejong (KR); Dongyong Kwak, Daejeon (KR); Junsang Min, Seoul (KR)

(73) Assignee: KEPCO NUCLEAR FUEL CO., LTD., Daejeon (KR)

(21) Appl. No.: 16/268,020

(22) Filed: Feb. 5, 2019

Related U.S. Application Data
(63) Continuation of application No. PCT/KR2016/013022, filed on Nov. 11, 2016.

(30) Foreign Application Priority Data
Aug. 5, 2016 (KR) 10-2016-0099947

(51) Int. Cl. B01D 11/04

(52) U.S. Cl. CPC B01D 11/043

(57) ABSTRACT

A modular extraction column. End blocks respectively have a flange on one side. A body block includes a plurality of column modules stacked on each other and coupled to the flanges of the end blocks in a surface contact manner. Each column module includes first and second module flanges provided on opposite ends and an accommodating portion provided in an inner portion to have a predetermined area. The column modules are coupled to each other such that the first module flange of one column module faces the second module flange of an adjacent column module. An inner structure is received in the accommodating portions of the plurality of column modules to distribute a fluid. The end blocks and the body block communicate with each other. The accommodating portion of each of the column modules has a quadrangular cross-section in a direction perpendicular to a longitudinal direction thereof.

### CROSS-REFERENCE TO RELATED PATENT APPLICATIONS

This patent application is a continuation of PCT/KR2016/013022, filed Nov. 11, 2016, which claims priority to Korean Patent Application No. 10-2016-0099947, filed Aug. 5, 2016, the entire teachings and disclosure of which are incorporated herein by reference thereto.

### TECHNICAL FIELD

The present invention relates to a modular extraction column.

### BACKGROUND ART

An extraction column is used in a variety of chemical plants, as major equipment in an extraction process. The extraction column performs extraction by allowing a heavy phase of higher density to be input into a top head thereof to flow downwards while allowing a light phase of lower density to be input into a bottom head thereof, such that the two phases continuously come into countercurrent contact. Such extraction columns are fabricated in a variety of diameters and heights according to the properties of fluid in processes. Inner structures having a variety of shapes may be added to increase the contact area between fluids as required.

As a prior-art document related to extraction column, Korean Patent No. 10-1522771 (patented on May 26, 2015) disclosed a vertical liquid-liquid separation apparatus based on the principle of a mixer-settler apparatus. The disclosed apparatus has superior acid/base resistance, with parts thereof being able to be easily operated.

A typical extraction column as disclosed in the prior-art document has an integrated structure, in which the height of the column is determined using a specific standard, such as height of transfer unit (HTU) and number of transfer unit (NTU). Once the extraction column is constructed, it is difficult to disassemble the extraction column into pieces. It is therefore difficult to change the inner structure of the extraction column, replace a damaged structural part of the extraction column, or remove internal contaminants when considering process operations of the extraction column.

### RELATED ART DOCUMENT

Korean Patent No. 10-1522771 (May 26, 2015)

### BRIEF SUMMARY

Accordingly, the present invention has been made keeping in mind the above problems occurring in the related art, and the present invention is intended to propose a modular extraction column that can be easily fabricated and constructed, and after construction, allows for easy maintenance, such as replacement of a damaged structural part and removal of contaminants.

In order to achieve the above object, according to one aspect of the present invention, a modular extraction column may include: end blocks respectively having a flange on one side; a body block including a plurality of column modules stacked on each other, the plurality of column modules being coupled to the flanges of the end blocks in a surface contact manner, each of the plurality of column modules including a first module flange and a second module flange provided on opposite ends and an accommodating portion provided in an inner portion to have a predetermined area, wherein the plurality of column modules are coupled to each other such that the first module flange of one column module among the plurality of column modules faces the second module flange of an adjacent column module among the plurality of column modules; and an inner structure received in the accommodating portions of the plurality of column modules to distribute a fluid. The end blocks and the body block communicate with each other, the accommodating portion of each of the plurality of column modules having a quadrangular cross-section in a direction perpendicular to a longitudinal direction thereof.

According to the present invention, the modular extraction column facilitates the assembly and construction thereof, since the modular extraction column includes the end blocks and the body block consisting of the column modules.

In addition, according to the present invention, after the construction of the modular extraction column, it is possible to easily change the inner structure or the volume of the extraction column by changing the number of the column modules of the body block, which is advantageous.

Furthermore, according to the present invention, the inner structure is provided the shape of a cartridge for each column module and the cover is provided in the open area of the column module. It is therefore easy attach or detach the inner structure to or from the column module, thereby advantageously facilitating maintenance, such as replacement of a damaged portion of the inner structure or removal of contaminants.

In addition, according to the present invention, the cross-section of the modular extraction column in the direction perpendicular to the longitudinal direction is quadrangular (more particularly, rectangular) instead of being curved, thereby advantageously facilitating fabrication.

The effects of the present invention are not limited to the above-described effects but the other effects will be apparent to those skilled in the art to which the present invention belongs from the specification and the accompanying drawings.

### BRIEF DESCRIPTION OF DRAWINGS

FIG. 1 is an assembly view schematically illustrating a modular extraction column according to an exemplary embodiment of the present invention;

FIG. 2 is a perspective view illustrating a column module according to the exemplary embodiment of the present invention;

FIG. 3A is a front elevation view illustrating the column module shown in FIG. 2;

FIGS. 3B and 3C are cross-sectional views taken along lines A-A′ and B-B′ in FIG. 3A;

FIGS. 4A and 4B are front elevation views illustrating the column module and the cover according to the exemplary embodiment of the present invention; and

FIGS. 5A to 5E are perspective assembled views schematically illustrating examples of the inner structure according to the exemplary embodiment of the present invention.

### DETAILED DESCRIPTION

Descriptions of specific structures and functions disclosed in the following embodiments of the present invention are only provided to render exemplary embodiments according to the concept of the present invention. The embodiments according to the concept of the present invention may be implemented in a variety of forms. In addition, it is to be understood that the present description is not intended to limit the present invention to those exemplary embodiments. On the contrary, the present invention is intended to cover not only the exemplary embodiments, but also various alternatives, modifications, equivalents, and substitution, that may be included within the spirit and scope of the present invention.

Hereinafter, the present invention will be described in detail with reference to the drawings. Herein, the same reference numerals will be used throughout the drawings to refer to the components having substantially the same functions.

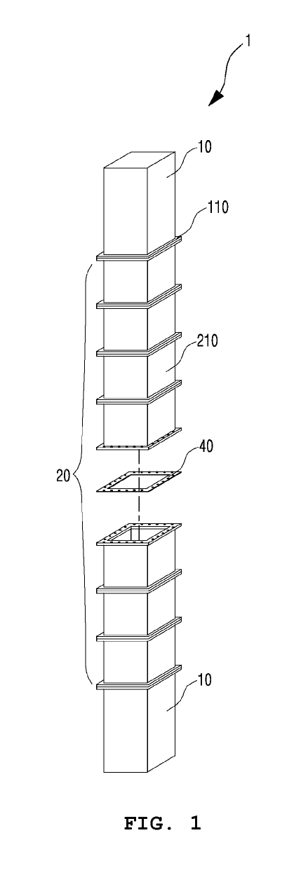

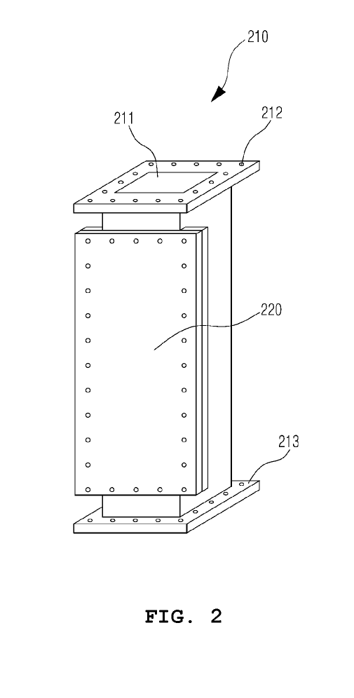

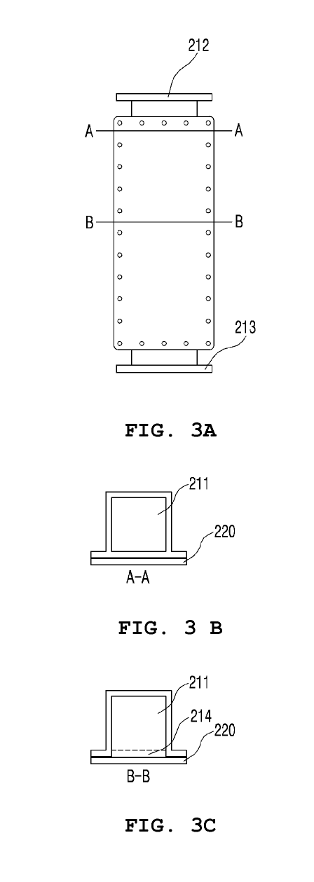

FIG. 1 is an assembly view schematically illustrating a modular extraction column according to an exemplary embodiment of the present invention, FIG. 2 is a perspective view illustrating a column module according to the exemplary embodiment of the present invention, FIG. 3A is a front elevation view illustrating the column module shown in FIG. 2, and FIGS. 3B and 3C are cross-sectional views taken along lines A-A′ and B-B′ in FIG. 3A. As illustrated in FIGS. 1 to 3C, the modular extraction column includes end blocks 10, a body block 20, and inner structures.

The end blocks 10 are disposed on both ends of the modular extraction column 1. Each of the end blocks 10 has a flange on one side, and is coupled to the body block 20.

The body block 20 is a multi-stage structure, with both ends thereof being coupled to the flanges 110 of the end blocks 10 in a surface contact manner. The body block 20 includes column modules 210 and covers 220. The body block 20 is formed by stacking the column modules 210 having a predetermined length on one another, instead of having an integrated structure.

As illustrated in FIGS. 2, 3A to 3C, each column module 210 includes a first module flange 212 and a second module flange 213. An accommodating portion 211 having a predetermined area is formed within the column module 210. In addition, the column module 210 has an open area 214 in one side. The open area 214 is able to communicate with the accommodating portion 211 within the column module 210.

The length of the column module 210 may be adjusted considering the ease of manufacturing, fabrication, and maintenance according to the space of construction.

The modular extraction column 1 according to the present embodiment as described above advantageously facilitates the assembly and construction thereof, since the modular extraction column 1 includes the end blocks 10 and the body block 20 consisting of the column modules 210.

In addition, after the construction of the modular extraction column, it is possible to easily change the inner structure or the volume of the extraction column by changing the number of the column modules 210 of the body block 20, which is advantageous.

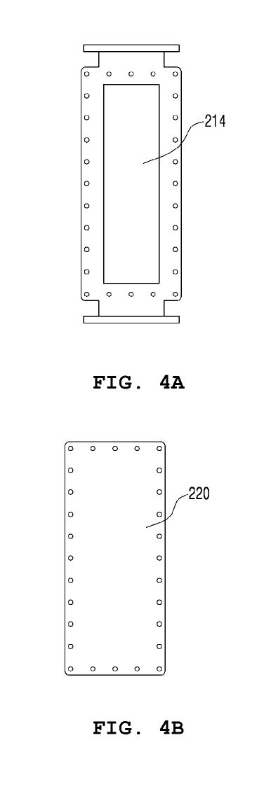

FIGS. 4A and 4B are front elevation views illustrating the column module 210 and the cover 220 according to the exemplary embodiment of the present invention. As illustrated in FIGS. 4A and 4B, the column module 210 further includes the cover 220. The cover 220 has a shape and size covering the open area 214 formed in one side of the column module 210, and can be detachably coupled to the side of the column module 210 to open and close the open area 214.

The cover 220 is detachably coupled to one side of the column module 210, such that a coupling portion thereof forms a flange. The cover 220 is coupled to the column module 210 using bolts. The cover 220 may further include a gasket 40 to prevent leakage in the connecting portion between the column module 210 and the cover 220.

Since the column module 210 according to the exemplary embodiment of the present invention has the cover 220, it is possible to easily attach or detach an inner structure 310 to or from each column module 210 through the open area 214. This advantageously facilitates maintenance, such as replacement of a damaged portion of the inner structure 310 or removal of contaminants.

The first module flange 212 and the second module flange 213 are provided coaxially on the opposite ends of the column module 210 to face away from each other. The first module flange 212 and the second module flange 213 may be arranged to abut against one or both of the flanges 110 of the end blocks 10 or the second module flange 213 and the first module flange 212 of the adjacent other column modules 210 to be coupled thereto in extended areas. In this case, the dimensions, shape, and size of the first module flange 212 are the same as those of the second module flange 213 and, furthermore, the flange 110, such that the column module 210 can be disposed without being restricted in the orientation thereof. Shortly, the end blocks 10 and the body block 20 can be coupled to each other using the flanges.

The end blocks 10 and the body block 20 may communicate with each other in the longitudinal direction while having quadrangular (more particularly, rectangular) cross-sections in the direction perpendicular to the longitudinal direction. In addition, the accommodating portion 211 of the body block 20 may have a quadrangular (more particularly, rectangular) cross-section in the direction perpendicular to the longitudinal direction.

The end blocks 10 and the body block 20 according to the embodiment of the present invention as described above have quadrangular (more particularly, rectangular) cross-sections in the direction perpendicular to the longitudinal direction. Since the quadrangular cross-section does not provide a curved surface, fabrication-involved operations, such as cutting or welding, are facilitated.

The end blocks 10 and the body block 20 may be stacked on and coupled to each other via gaskets 40. The gaskets 40 are provided in connecting portions between the flanges 110 of the end block 10 and the first module flange(s) 212 and the second module flange(s) 213 of the body block 20, thereby preventing leakage in the connecting portions.

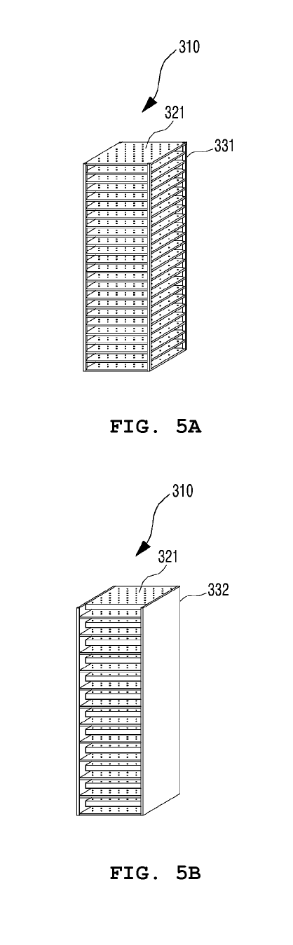

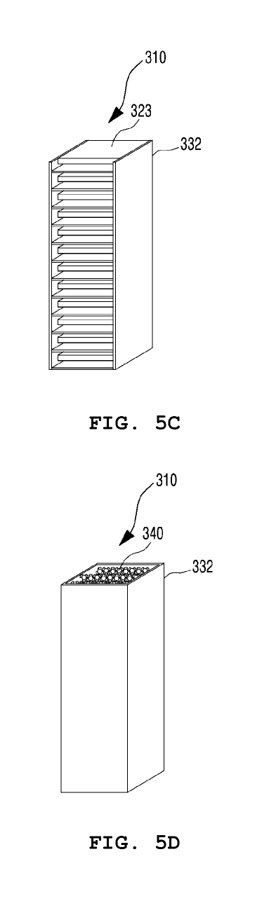

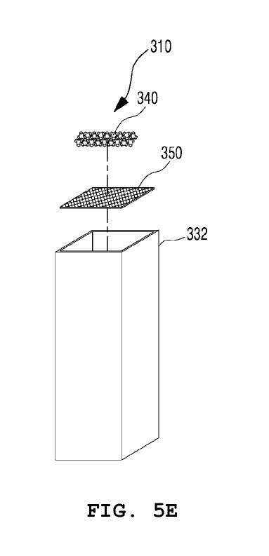

FIGS. 5A to 5E are perspective assembled views schematically illustrating examples of the inner structure 310 according to the exemplary embodiment of the present invention. As illustrated in FIGS. 5A to 5E, the internal structure 310 may have the shape of a cartridge that is introduced through the open area 214 and is seated in the accommodating portion 211 adjacent to the open area 214. The internal structure 310 is accommodated in the accommodating portion(s) 211 of the body block(s) 20 and functions to distribute fluid, thereby increasing the contact area between fluids.

A first embodiment of the inner structure 310 includes a structural body 320 and a support 330. The inner structure 310 is provided in each column module 210 of the modular extraction column 1. The inner structure 310 may be fabricated separately from the column module 210 to be coupled to the latter in order to increase the contact area between fluids.

In addition, the inner structure 310 may be fabricated with an outer size that does not form a gap between the inner structure 310 and the inner surface of the column module 210. Due to the quadrangular cross-sections, the modular extraction column according to the embodiment of the present invention can be easily fabricated, constructed, and assembled without leaving a gap between the inner structure 310 and the column module 210, differently from common extraction column having circular cross-sections. Consequently, the modular extraction column according to the embodiment of the present invention is able to have higher efficiency.

The structural body 320 may be formed by stacking a plurality of structural sections having the same shape on one another in the top-bottom direction to distribute a fluid in order to increase the contact area between fluids. The structural body 320 may be fabricated as one of a structure including perforated plates 321, a structure including sieve trays 322, or a structure including baffle trays 323.

The support 330 serves to support the structural body 320. When the structural body 320 is assembled by stacking the plurality of pieces on one another, the support 330 may be implemented as support legs 331 or support plates 332. The support legs 331 are coupled to the corners of the structural body 320 to support and fix the structural body 320. The support plates 332 may be provided as two or more support plates 332 to hold and fix the structural body 320. More specifically, the support plates 332 may be provided as a plurality of plates such that the edges of the plates are abutted against each other to form a rectangular horizontal cross-section. Alternatively, the support plates 332 may be implemented as a pair of right and left plates forming partitions, by which the structural body 320 is held and fixed.

The structural body 320 and the support 330 may be fabricated in a size that allows the structural body 320 and the support 330 to be disposed within the accommodating portion 211 of the column module 210. The structural body 320 and the support 330 may be coupled to each other using one, selected from among welding, rivets, bolts, and spline fitting, according to different process characteristics and fabrication convenience.

A second embodiment of the inner structure 310 may include the support 330 and stuffing 340. In addition, the second embodiment of the inner structure 310 may further include a stuffing holding film 350. The support 330 may include a plurality of support plates 332, the edges of which are coupled to each other to form a rectangular horizontal cross-section, such that a hollow inner area is defined within the support plates 332. The stuffing 340 may be accommodated in the hollow inner area and may be coupled to the support 330.

The stuffing holding film 350 may be a structure disposed on one or both sides of the support 330. The stuffing holding film 350 may allow fluids to pass therethrough while supporting stuffing 340 such that the stuffing 340 such is not drained by flows of fluid. Although the stuffing holding film 350 may a mesh structure having a predetermined size, this is not intended to be limiting.

The first embodiment and the second embodiment of the inner structure 310 may be determined suitably according to process characteristics.

The modular extraction column 1 disclosed with reference to FIGS. 1 to 5E is not limited to the specific length or shape but is only provided for a better understanding of the present invention to those skilled in the art to which the present invention belongs.

Although the exemplary embodiments of the present invention have been described for illustrative purposes, those skilled in the art will appreciate that various modifications, additions and substitutions are possible, without departing from the scope and spirit of the present invention as disclosed in the accompanying claims.

[Description of Reference Numerals]

| | |
|---|---|
| 1: modular extraction column | |
| 10: end block | 110: flange |
| 20: body block | 210: module |
| 211: accommodating portion | |
| 212: first module flange | |
| 213: second module flange | 214: open area |
| 220: cover | |
| 310: cartridge | 321: perforated plate |
| 322: sieve tray | 323: baffle tray |
| 331: support leg | 332: support plate |
| 340: stuffing | 350: stuffing holding film |
| 40: gasket | |

1. A modular extraction column comprising:
end blocks respectively having a flange on one side;
a body block comprising a plurality of column modules stacked on each other, the plurality of column modules being coupled to the flanges of the end blocks in a surface contact manner, each of the plurality of column modules comprising a first module flange and a second module flange provided on opposite ends and an accommodating portion provided in an inner portion to have a predetermined area, wherein the plurality of column modules are coupled to each other such that the first module flange of one column module among the plurality of column modules faces the second module flange of an adjacent column module among the plurality of column modules; and
an inner structure received in the accommodating portions of the plurality of column modules to distribute a fluid,
wherein the end blocks and the body block communicate with each other, the accommodating portion of each of the plurality of column modules having a quadrangular cross-section in a direction perpendicular to a longitudinal direction thereof.

2. The modular extraction column according to claim 1, wherein the end blocks and the body block are coupled to and stacked on each other such that the flanges of the end blocks are coupled to the first module flange of a predetermined column module among the plurality of column modules and the second module flange of the opposite column module among the plurality of column modules.

3. The modular extraction column according to claim 1, wherein each of the plurality of column modules further comprises a cover disposed adjacent to an open area formed in one side of the each column module, the cover being detachably coupled to a predetermined portion of the each column module to open and close the open area.

4. The modular extraction column according to claim 3, wherein the inner structure comprises a cartridge introduced through the open area and seated in the accommodating portion communicating with the open area.

5. The modular extraction column according to claim 4, wherein the inner structure comprises:
a structural body formed of a plurality of structural sections having a predetermined shape and stacked in a top-bottom direction; and
a support fixedly supporting the structural body.

6. The modular extraction column according to claim 5, wherein the structural body comprises one selected from the group consisting of perforated plates, sieve trays, and baffle trays.

7. The modular extraction column according to claim 5, wherein the support comprises:
support legs coupled to corners of the structural body to support and fix the structural body; or
two or more support plates holding and fixing the structural body,
wherein the structural body and the support are coupled to each other using one selected from the group consisting of welding, rivets, bolts, and spline fitting.

8. The modular extraction column according to claim 4, wherein the inner structure comprises:
a support having a quadrangular horizontal cross-section and a hollow inner area; and
stuffing accommodated in the hollow inner area.

9. The modular extraction column according to claim 8, wherein the inner structure further comprises one or two stuffing holding films disposed on one or both sides of the support, the stuffing holding films allowing fluids to pass therethrough.
